(19) United States
(12) Patent Application Publication
(10) Pub. No.: US 2015/0246407 A1
(43) Pub. Date: Sep. 3, 2015

(54) WIRE FEEDING SYSTEM

(71) Applicant: AWDS TECHNOLOGIES SRL, Rovereto (TN) (IT)

(72) Inventors: Carlo Gelmetti, Lazise (VR) (IT); Filippo Corradini, Isera (TN) (IT)

(73) Assignee: AWDS TECHNOLOGIES SRL, Rovereto (TN) (IT)

(21) Appl. No.: 14/195,497

(22) Filed: Mar. 3, 2014

(51) Int. Cl. B23K 9/12

(52) U.S. Cl. CPC B23K 9/125

(57) ABSTRACT

A wire feeding system, in particular for feeding welding wire, has a wire movement sensing device adapted for being mounted onto a wire guideliner, and a feed assisting device for feeding welding wire depending from signals received from the wire movement sensing device.

The invention relates to a wire feeding system, in particular for feeding welding wire.

Wire feeding systems are commonly used for feeding welding wires from a supply source, for example a container in which a significant amount (up to several hundred kilograms) of welding wire is being stored, to a point called welding arc where the welding wire is being melt through a welding torch, with the purpose of joining metal parts. Since the welding torch is usually connected to a welding robot and continuously moving, the welding wire has to be fed through a wire guiding liner from the container to the welding torch. The passing of the welding wire through the inevitable bends and curvatures on the wire guiding liner necessarily creates a certain amount of friction and drag. More curves along the wire guiding liner can worsen the problem to the point that it becomes very difficult for the wire feeding system to function properly and to guarantee the necessary smooth feeding.

In conventional welding applications, a single feeding device pulls the wire from the container and feeds it to the welding torch and it is placed between the wire source (the container) and the welding torch. In some other welding applications the feeding device itself contains the wire source in the form of a small spool and feeds the wire to the welding torch.

In robotic and automated applications, which are designed to maximize the productivity, the trend goes towards using large bulk packs containing from few hundred kilograms to more than one ton of welding wire. These bulk containers have to be positioned in a safe area at a significant distance from the device feeding the welding wire to the welding torch and preferably in an area which can be easily accessed by a forklift. This results in the welding wire having to be guided over significant distances from the container towards the welding torch. As a single wire feeding device close to the welding torch is not always capable of reliably advancing the welding wire, systems are known which use the combined action of a so-called master feeder (the wire feeding device close to the welding torch) and a so-called slave wire feeder (a second wire feeder installed remotely from the welding torch, close to the wire supply bulk container). Both wire feeders are equipped inside with the software and hardware necessary to synchronize their movements so that the welding wire is being fed to the welding torch by the combined pulling effect of the master feeder and the pushing effect of the slave feeder and this interaction between the two units is possible because both are normally supplied by the same manufacturer, but this represents, for the market, a limitation of competitiveness and an increase of costs for the end users.

In the attempt to reduce the dependence from the master and slave feeder manufacturers, less advanced systems are known which employ a so-called feed assist booster operating independently from the wire feeder close to the welding torch. The feed assist booster detects when welding wire is being pulled by the wire feeder, and then automatically engages through a clutch. However, the action of the wire feeder close to the welding torch, assisted by the independent feeding booster, is not as reliable and efficient as the combined synchronized cooperation of master and slave feeding systems. This is due to the fact that the booster feeder always reacts with a certain delay, which increases proportionally with the length of the wire guide liner. When the wire feeder close to the welding torch starts its wire feeding action, a few seconds pass before the feed assist booster recognizes that feeding is required. This is due to the inherent flexibility of the wire guiding system which allows feeding of some centimeters of welding wire into the wire guiding system (or pulling it from the wire guiding system) at one end without there being a movement of the wire at the other end. This effect is known as backlash. The same effect noticeable at a start of the feeding action can be noticed at a stop of the feeding action. The wire feeder close to the welding torch will stop without the booster feeder noticing this immediately. The backlash results in the welding wire not being advanced at the welding torch with the speed actually requested. In other words, a wire pushing booster, not synchronized and not directly interacting with the wire pulling master feeder, does not promptly and accurately react to the starts and stops and the wire feed speed imposed by the master feeder itself and this makes the whole welding process extremely unreliable. A delayed feeding assistance by the booster at the feeding start can cause welding torch contact tip burnbacks and a delayed feeding interruption by the booster can cause the booster rolls to scratch and deform the wire surface.

The object of the invention is to provide a wire feeding system which allows to reliably assisting welding wire feeding over large distances without involving a complicated or expensive system and without any need of synchronization between the master wire feeder and the assisting booster feeder.

For solving this object, the invention provides a wire feeding system, in particular for feeding welding wire, having a wire movement sensing device formed as a self-contained unit and adapted for being mounted to a wire guide, and an assisting feeding device for assisting the feeding welding wire depending from signals received from the wire movement sensing device. The invention is based on the idea of actively controlling a feed assisting device which acts in a manner similar to the known booster feeders, by employing the wire movement sensing device close to the “main” master feeder which usually is the wire feeder close to the welding torch. The wire movement sensing device is implemented as a small unit which is physically independent from the master feeder and can be mounted at a suitable location along the path of the wire, preferably close to the master feeder.

Preferably, the wire movement sensing device detects the speed at which the welding wire moves with respect to the wire movement sensing device. This allows controlling the feeding device such that it helps pushing welding wire into the wire guiding system at exactly the same speed at which the “main” feeder advances the welding wire. The wire movement sensing device enables the pushing feed assist device to immediately react to the starts and stops of the main master feeder.

According to a preferred embodiment of the invention, the wire movement sensing device has a sensing element adapted for physically contacting the welding wire, in particular a sensing wheel. This allows promptly sensing the movement of the wire with a simple, reliable construction.

According to an alternative embodiment, the wire movement sensing device has a sensing element adapted for detecting wire movement in a non-contacting manner, in particular an optical or acoustic sensor. The main advantage of a non-contacting detection of the wire movement is that there is no element in the wire movement sensing device which collects dirt and contaminations from the welding wire moving therethrough.

According to a preferred embodiment, the wire movement sensing device has a coupling for being connected to a master feeder or on the wire guide liner at a close distance from the wire feeder. This allows to quickly connect the wire movement sensing device in the immediate proximity to the master feeder where a reaction to the movements imparted by the master feeder is more effective than at the feed assist booster end where the movement is distorted by the backlash effect.

Preferably, the wire movement sensing device has at least one coupling for being connected to a wire guide liner. This allows to easily integrate the wire movement sensing device into existing installations having a flexible wire guide liner.

Preferably, the coupling is a quick-connect coupling such that an installation is possible without tools. This also simplifies disassembly of the system for an easy maintenance or cleaning.

According to an embodiment of the invention, the wire movement sensing device and the wire feed assist pushing device are connected by means of a cable. This allows establishing a very reliable connection without significant costs.

Preferably, the cable is being integrally provided in a wire liner so that no separate installation of a cable is necessary. Further, the cable is perfectly protected in the liner.

According to an alternative embodiment, the wire movement sensing device and the wire feeding device are connected by means of a near field communication system, in particular a WLAN or Bluetooth transmission. Such communication system avoids the necessity of having a physical connection between the wire movement sensing device and the wire feeding device.

Preferably, a master feeder is provided adjacent to which the wire movement sensing device is installed as a unit independent from the master feeder, and the assist feeding device receiving the signals from the wire movement sensing device is installed remote from the master feeder, in particular adjacent to a welding wire container. Such installation results in a combined push-pull action of the two feeding devices, which are synchronized on the basis of the signal provided by the wire movement sensing device.

The invention will now be described with reference to the enclosed drawings. In the drawings,

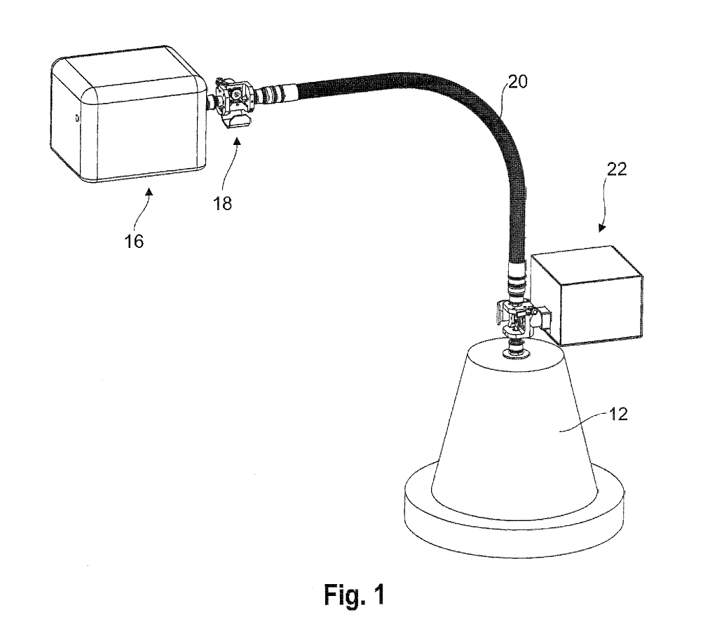

FIG. 1 shows a first example of a system according to the invention in a perspective view,

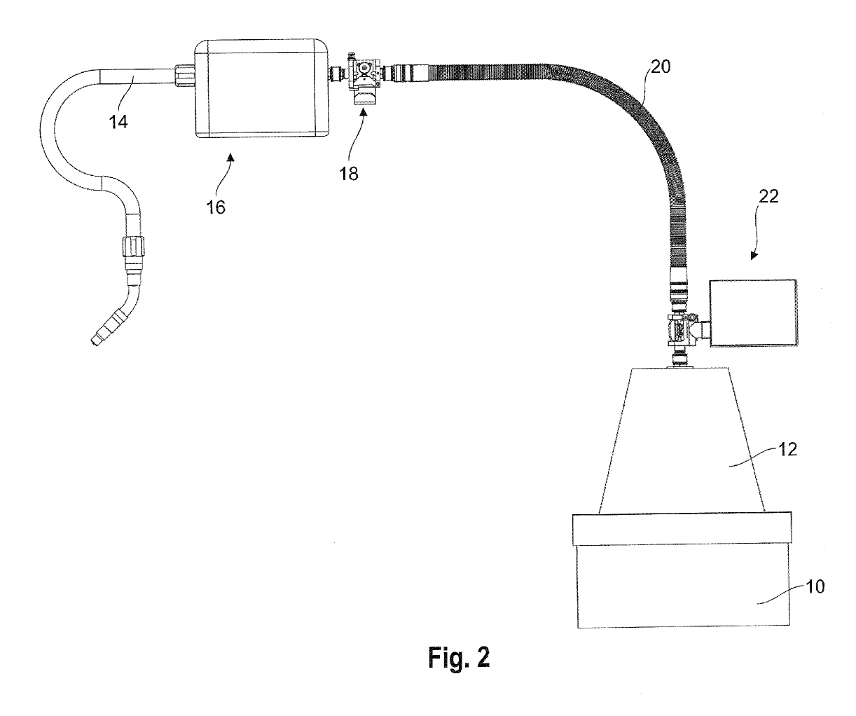

FIG. 2 shows the system of FIG. 1 in side view,

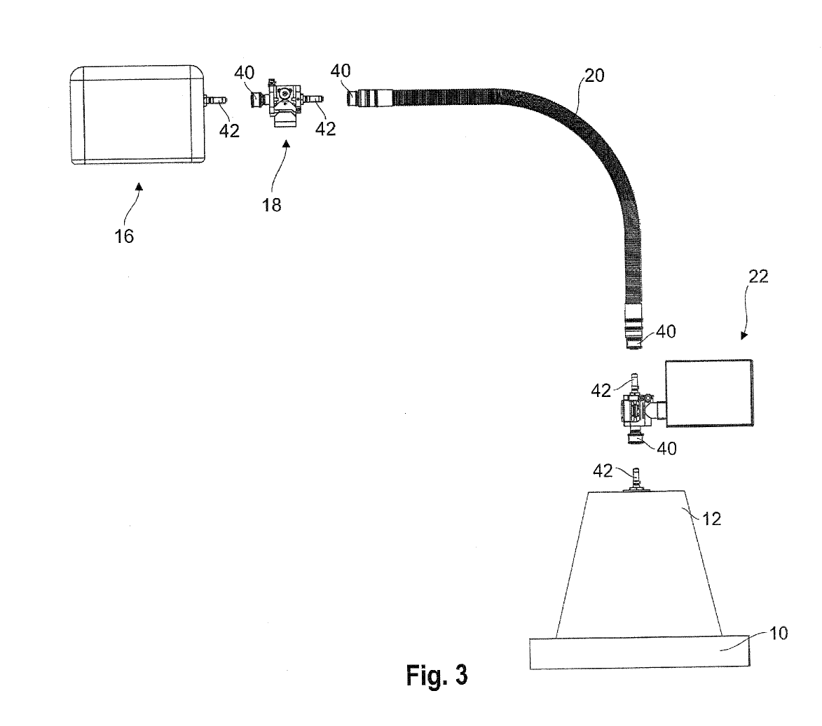

FIG. 3 shows the system of FIG. 1 in an exploded view,

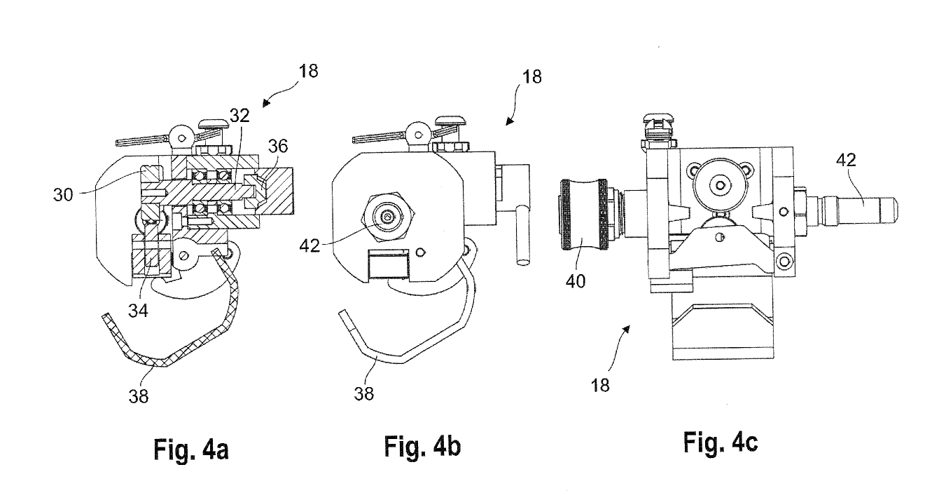

FIGS. 4a-4c show the wire movement sensing device in a cross section, a first side view and a second side view, respectively with the wire movement sensing device being in an opened condition,

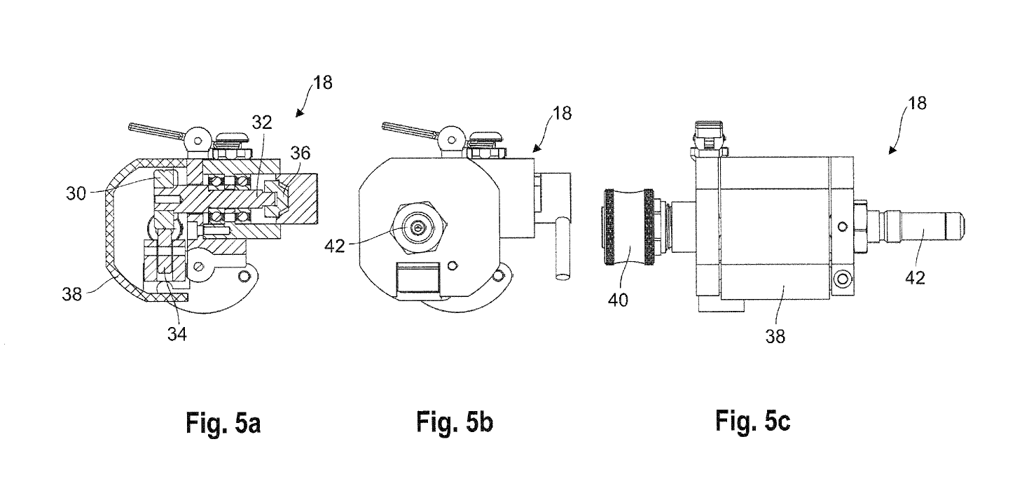

FIGS. 5a-5c show the wire movement sensing device of FIGS. 4a-4c in a closed condition,

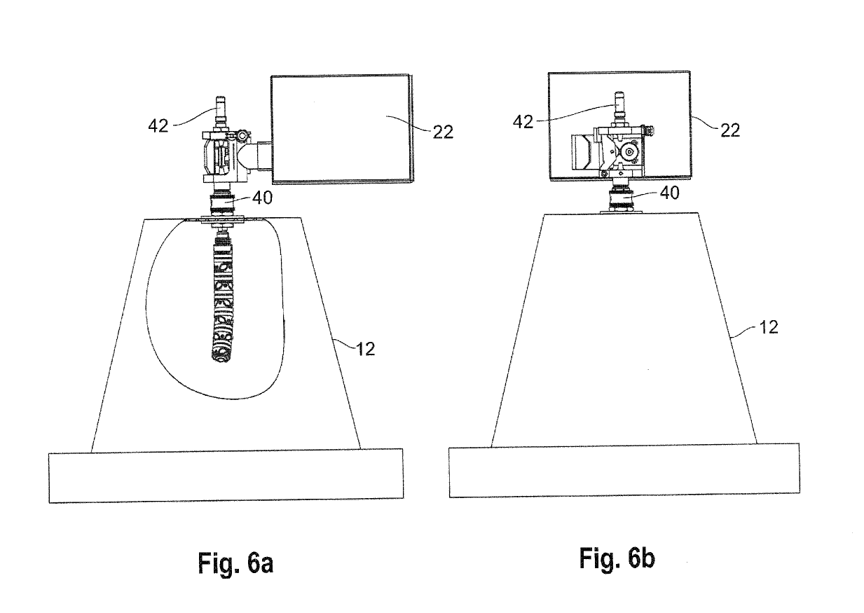

FIGS. 6a-6b show the wire feeder in a first and a second side view, respectively,

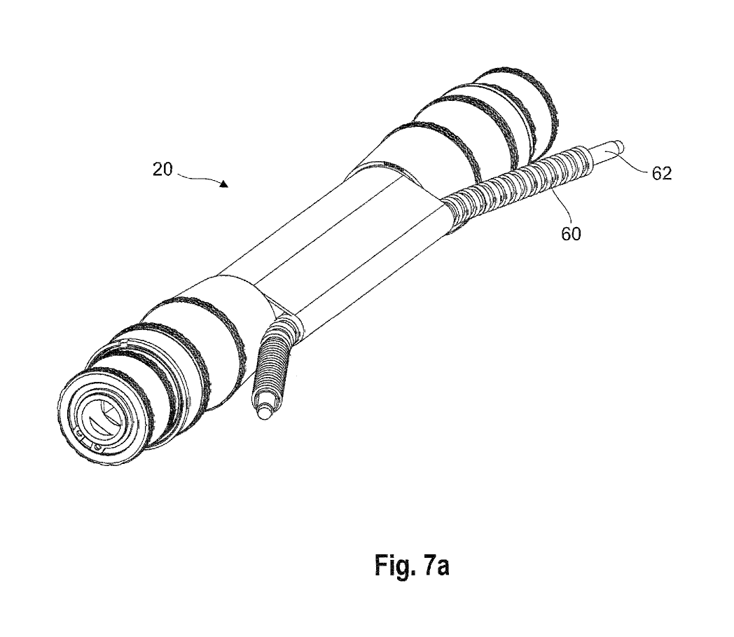

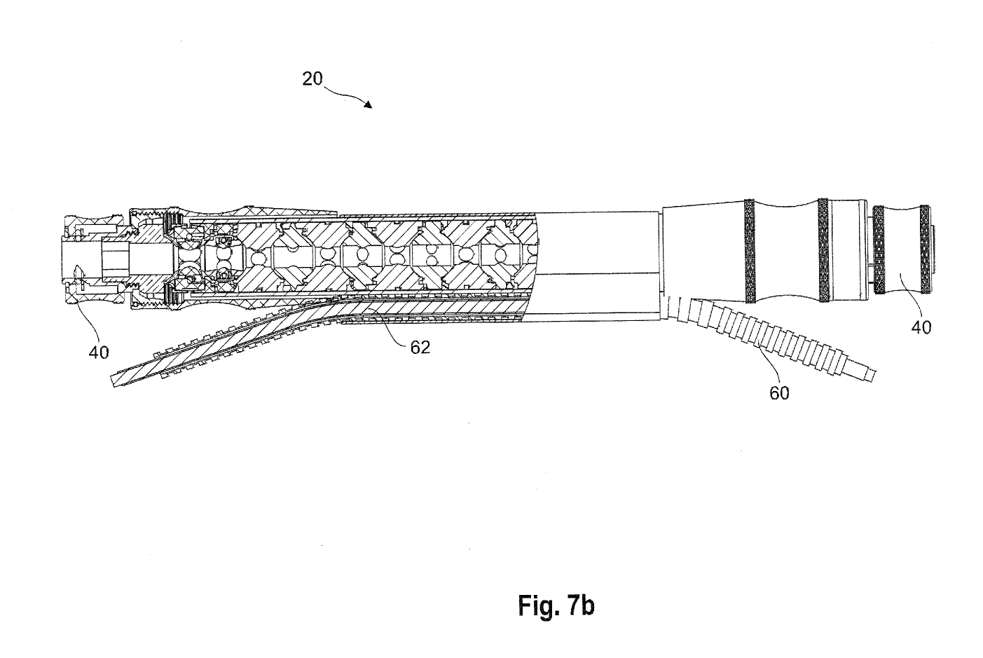

FIGS. 7a-7b show a wire liner used in the system of FIG. 1 with an integrated cable, and

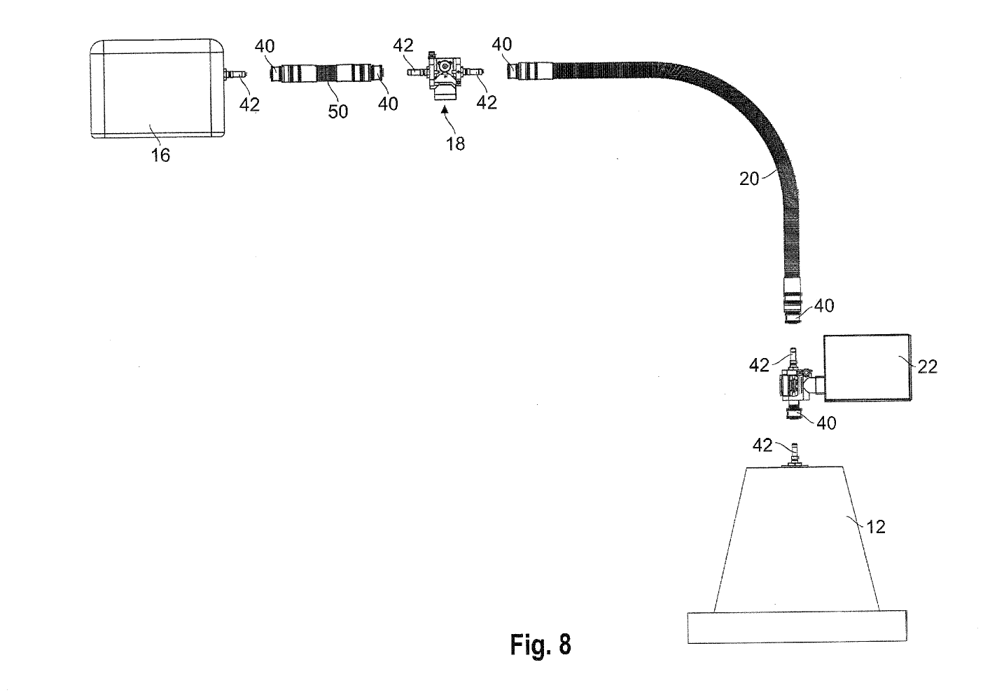

FIG. 8 shows a wire feeding system according to a second embodiment of the invention in an exploded view.

In FIGS. 1 to 3, a wire feeding system is shown for feeding welding wire from a wire supply source (schematically depicted here as a container 10 on which a dome 12 is placed) to a schematically depicted welding torch 14. The wire feeding system comprises a master feeder 16, a wire movement sensing device 18, a wire guide 20 and a wire feed assist device 22.

Master feeder 16 is arranged close to welding torch 14 and is responsible for properly supplying welding wire to the welding torch. Wire feed assist device 22 can be considered as an auxiliary feeding device which is arranged at a distance from master feeder 16. Wire feed assist device 22 can be arranged adjacent to bulk container 10 in which the welding wire is being stored. As an alternative, it can be arranged at a certain distance from the container at an intermediate position between the container and the master feeder.

Wire guiding system 20 is shown here as a short piece of welding wire liner. In practice, wire guiding system 20 can be formed of many meters (up to 50 or even more meters) of a flexible hose which is provided in its interior with a plurality of small rolls which guide the welding wire with low friction. Examples of such wire liners can be found in EP 2 695 696 A1 and DE 20 2011 104 120, the disclosure of which is incorporated herein by reference.

Wire movement sensing device 18 (please see also FIGS. 4 and 5) has a sensing wheel 30 arranged on a sensing shaft 32, and a counter wheel 34 provided for biasing welding wire against sensing wheel 30. When welding wire is being pulled through wire movement sensing device 18, sensing wheel 30 is being entrained by the welding wire. Rotation of sensing shaft 32 is detected by a schematically depicted encoder 36 which provides a signal indicating the speed of the welding wire relative to wire movement sensing device 18. As can be seen by comparing FIGS. 4 and 5, a cover 38 can be pivoted between an opened position (please see FIG. 4) in which counter wheel 34 is in a certain distance from sensing wheel 30 so as to allow insertion of the welding wire, and a closed position (please see FIG. 5) in which counter wheel 34 is biased against sensing wheel 30.

Wire feed assist device 22 is basically of a known construction with a motor and drive device for advancing welding wire depending from an external signal.

For connecting the components of the wire feeding system, quick-connection couplings are provided which consist of a coupling sleeve 40 and a stud 42 to be received within sleeve 40 of the respective other component. The elements 40, 42 of the quick-connection couplings are arranged in a suitable manner on master feeder 16, wire movement sensing device 18, wire guiding system 20, wire feed assist device 22 and container dome 12 so as to allow establishing a reliable connection between the respective components.

The signals generated by encoder 36 in wire movement sensing device 18 are provided to wire feed assist device 22 which then accordingly pushes the welding wire into wire guiding system 20. A connection between wire movement sensing device 18 and wire feeding device 22 can either be established by means of a cable or by means of a near field communication system.

If a cable is being used, it can simply be plugged into appropriate plug connectors at the wire movement sensing device 18 and the wire feed assist device 22. The cable can then be attached to the outside of wire liner 20 by means of cable straps, or a cable fully integrated into wire liner 20 (e.g. by being embedded into the plastic or Kevlar sheath) can be used. Then, only a short connection cable is necessary between wire movement sensing device 18 and a plug connector provided at the respective end of wire liner 20, and a short cable between a plug connector provided at the opposite end of wire liner 20 and a plug connector at wire feeding device 22.

In FIGS. 7a and 7b, a similar solution is shown in which a hose 60 is being integrated into the liner. A cable 62 can then be introduced into the hose so as to extend through hose 60 in a protected manner.

If a near field communication system is employed between wire movement sensing device 18 and wire feed assist device 22, a reliable and inexpensive communication standard such as WLAN or Bluetooth or ZigBee wireless can be used. Preferably, the components of the wire feeding system then automatically connect to each other.

As an alternative to using sensing wheel 30, a non-contacting sensing mechanism can be used which is based on detecting movement of the wire by optical or acoustic sensing systems.

In operation, wire movement sensing device 18 immediately detects any movement of the welding wire “requested” by master feeder 16 since wire movement sensing device 18 is arranged very close to master feeder 16. The requested movement of the welding wire is then transmitted to wire feed assist device 22 which provides a synchronized feeding action.

In FIG. 8, an alternative installation is shown in which wire movement sensing device 18 is not arranged immediately adjacent master feeder 16 but at a small distance therefrom. This is due to an intermediate liner 50 being arranged between master feeder 16 and wire movement sensing device 18. Intermediate liner 50 introduces greater flexibility for arranging wire movement sensing device 18. It is however essential that intermediate liner 50 is short enough so as to not introduce significant backlash distortion into the feeding system. The intermediate placement of the wire movement sensing device, between two segments of wire guide liner and at a slight distance from the master feeder, can become necessary in order to protect the sensing device from possible damages which can be caused by the sudden movements of the robot arm on which the feeder is sometimes installed.

1. Wire feeding system, in particular for feeding welding wire, having a wire movement sensing device adapted for being mounted to a wire guideliner as a self-contained stand-alone unit, and a feed assisting unit for feeding welding wire which is controlled by the signals received from the wire movement sensing device.

2. The wire feeding system of claim 1, wherein the wire movement sensing device senses the speed at which the welding wire moves with respect to the wire movement sensing device.

3. The wire feeding system of claim 1, wherein the wire movement sensing device has a sensing element adapted for physically contacting the welding wire, in particular a sensing wheel.

4. The wire feeding system of claim 1, wherein the wire movement sensing device has a sensing element adapted for detecting wire movement in a non-contacting manner, in particular an optical or acoustic sensor.

5. The wire feeding system of claim 1, wherein the wire movement sensing device has a coupling for being connected to a master feeder.

6. The wire feeding system of claim 1, wherein the wire movement sensing device has at least one coupling for being connected to a wire liner.

7. The wire feeding system of claim 5, wherein the coupling is a quick-connect coupling.

8. The wire feeding system of claim 1, wherein the wire movement sensing device and the wire feed assisting device are connected by means of a cable.

9. The wire feeding system of claim 8, wherein the cable is integrally provided in a wire guide liner.

10. The wire feeding system of claim 8, wherein the cable is provided within a tube or hose integrated into a wire guide liner.

11. The wire feeding system of claim 1, wherein the wire movement sensing device and the wire feeding device are connected by means of a near field communication system, in particular WLAN or Bluetooth or ZigBee wireless.

12. The wire feeding system of claim 1, wherein a master feeder is provided adjacent to which the wire movement sensing device is installed as a unit independent from the master feeder, and the feed assisting device receiving the signals from the wire movement sensing device being installed remotely from the master feeding, in particular adjacent a welding wire container.
